(19) United States
(12) Patent Application Publication
(10) Pub. No.: US 2010/0329480 A1
(43) Pub. Date: Dec. 30, 2010

(54) HIGHLY DIRECTIVE ENDFIRE LOUDSPEAKER ARRAY

(75) Inventor: Marinus Marias Boone, Zoetermeer (NL)

Correspondence Address: FLIESLER MEYER LLP, 650 CALIFORNIA STREET, 14TH FLOOR, SAN FRANCISCO, CA, 94108, US

(73) Assignee: TECHNISCHE UNIVERSITEIT DELFT, Delft (NL)

(21) Appl. No.: 12/597,906

(22) PCT Filed: Apr. 22, 2008
(86) PCT No.: PCT/NL08/50233

§ 371 Date: Nov. 10, 2009

(30) Foreign Application Priority Data
Apr. 27, 2007 (EP) 07107107.0

(51) Int. Cl. H04R 1/20

(52) U.S. Cl. 381/94.1; 381/182

(57) ABSTRACT

A loudspeaker system with an endfire array of three or more loudspeakers (Zₙ, n=3, 4, . . . N) arranged on a line. The system has a set of filters (Fₙ, n=3, 4, . . . N), each loudspeaker (Zₙ) being connected to one corresponding filter (Fₙ). The filters (Fₙ) are super resolution beamforming filters such as to provide the endfire array with a pre-designed directivity index (DI) and a pre-designed noise sensitivity (NS).

### FIELD OF THE INVENTION

The invention relates to the field of directive endfire loudspeaker arrays.

### BACKGROUND OF THE INVENTION

Control of the directivity of loudspeaker systems is important in applications of sound reproduction with public address systems. The use of loudspeaker arrays shows great advantages to bundle the sound in specific directions. Usually, in use, the loudspeakers are placed on a vertical line and the directivity is mainly in a plane perpendicular to that line. For that purpose the loudspeakers are fed with the same input signal and this leads to so-called broadside beamforming. Using delays between the input signals to the loudspeakers, the beamforming can also be directed to other directions. In the extreme, the radiation direction is along the line of the loudspeakers and this is called endfire beamforming. Endfire beamforming is well known in microphone array technology, but it is not often used in loudspeaker technology, although there are a few exceptions.

J. A. Harrell, “Constant-beamwidth one-octave bandwidth end-fire line array of loudspeakers”, J. Audio Eng. Soc., Vol. 43, No. 7/8, 1995 July/August, pp. 581-591, discloses such an endfire array where signals to be converted by loudspeakers into sound are processed with a delay and beamforming technique.

M. M. Boone and O. Ouweltjes, “Design of a loudspeaker system with a low-frequency cardiod-like radiation pattern”, J. Audio Eng. Soc., Vol. 45, No. 9, September 1997, pp. 702-707, disclose a loudspeaker system with two closely spaced loudspeakers arranged in an endfire arrangement. The filters used to provide the loudspeakers with input signals are optimized based on a gradient principle.

### SUMMARY OF THE INVENTION

It is an object of the present invention to provide a loudspeaker array with improved endfire beamforming.

To that effect, the present invention provides a loudspeaker system as defined in independent claim 1.

For the case of two loudspeakers, the gradient principle as known from Boone and Ouweltjes may be said to coincide with optimization based on super resolution beamforming signal processing. Therefore, the invention as claimed is restricted to the case where the number of loudspeakers and corresponding filters is 3 or higher.

With a loudspeaker array thus defined a higher directivity index can be obtained than with delay and sum beamforming.

In an embodiment, the invention provides a set of filters for an endfire array as defined in the claims.

### BRIEF DESCRIPTION OF THE DRAWINGS

The invention will be explained in detail with reference to some drawings that are only intended to show embodiments of the invention and not to limit the scope. The scope of the invention is defined in the annexed claims and by its technical equivalents.

The drawings show:

FIG. 1 shows a general overview of a loudspeaker array with a plurality of filters and a processor to supply the loudspeakers with an input signal;

FIGS. 2a and 2b show directional characteristics of arrays with different spacings of the loudspeakers;

FIGS. 3a and 3b, respectively, show changes of evaluation characteristics in dependence on number of loudspeakers for the directivity index DI and the noise sensitivity NS, respectively;

FIGS. 4a and 4b show changes of evaluation characteristics in dependence on the value of a stability factor;

FIG. 5 shows plots of a directivity index and noise sensitivity;

FIGS. 6a and 6b, respectively, show directivity index and noise sensitivity, respectively, of a constant beam width array system;

FIG. 7 shows a directional pattern of the system according to FIGS. 6a and 6b;

FIGS. 8a and 8b, respectively, show a boundary element model for numerical simulation for a single loudspeaker and a loudspeaker array, respectively;

FIGS. 9a and 9b, respectively, show a comparison of directional characteristics, i.e., directivity index derived by Equation (1) and the boundary element method, and noise sensitivity derived by Equation (5), respectively;

FIGS. 10a and 10b show comparisons of directivity patterns: for an actually filter designed under simple source assumption (FIG. 10a), and for the same filter considering the directivity of the loudspeakers (FIG. 10b);

FIGS. 11a, 11b, and 11c show measured directional patterns of a prototype endfire array with constant beam width: with a simple source assumption (FIG. 11a), using directivity of a single source obtained by a numerical model (FIG. 11b), and comparisons of the directivity index (FIG. 11c) for the different assumptions.

### DETAILED DESCRIPTION OF EMBODIMENTS

Below, results on the applicability of a loudspeaker line array are presented where the main directivity is in the direction of that line, using so-called endfire beamforming, resulting in a “spotlight” of sound in a preferred direction. Optimized beamforming techniques are used, which were earlier developed for the reciprocal problem of directional microphone arrays. Effects of the design parameters of the loudspeaker array system are investigated and the inventor of the present invention has found that a stability factor can be a useful parameter to control the directional characteristics. A prototype constant beam width array system has been built. Both simulations and measurements support theoretical findings.

Directional loudspeaker systems have already been studied by many researchers because of their useful application, e.g., a column array which addresses sound information in the plane of the ears of the listeners. In the case of a single loudspeaker unit, the directional characteristics depend on the Helmholtz number, which is related to the size of the radiating membrane and the wavelength. In the case of multiple loudspeaker units, a so-called loudspeaker array, the directional characteristics depend on the placement of the loudspeaker units within the array and on the filtering of the audio signals that are sent to the loudspeakers. A lot of work on the behaviour of transducer arrays has been carried out in the field of (electro-magnetic) antennas and also for loudspeaker and microphone systems. In recent researches, the representative methods to obtain highly directive beam patterns could be summarized by three methods: delay and sum, gradient method, and optimal beamforming. Among these, the optimal beamforming method is known to deliver a relatively high directivity as compared to other methods [1, 2]. The solution for optimal beamforming was suggested halfway the 20th century, however, it was only considered to be of academic interest, because of noise problems associated with equipment [2], but also because the implementation of the required filters was not possible with the analogue equipment of that time. A constrained solution considering the noise to solve this problem was suggested by Gilbert and Morgan [3], and with the advent of modern digital signal processing equipment, this technique has been applied to many practical situations.

One of these applications is the optimized beamforming that has been implemented in hearing glasses [1]. These are high directivity hearing aids mounted in the arms of a pair of spectacles, with usually four microphones at each side. Simulation and measurement results on the directivity of the hearing glasses have been presented at the 120^{th} AES-convention [4].

In the invention as described below, an endfire array system is applied for the design and development of a highly directive loudspeaker array system. The optimal beamforming method is also implemented, which is usually applied in microphone array systems. In accordance with the invention, the directivity index and the noise sensitivity (the inverse of the array gain) which are the most important design parameters of the optimal beamformer are set to an optimal value in accordance with a predetermined optimization criterion.

### Basic Theory

### Evaluation of the Array System

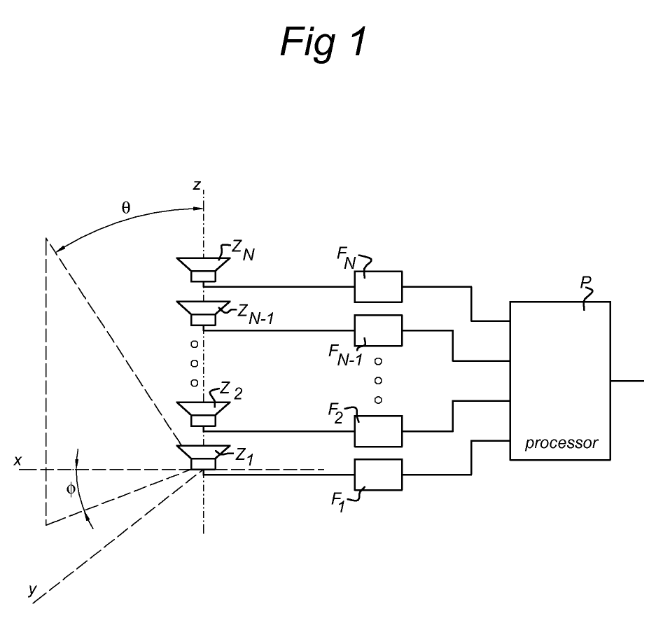

FIG. 1 shows a general geometry of a loudspeaker array. The array comprises a plurality of loudspeakers Zₙ (n=1, 2, 3, . . . , N), a plurality of filters Fₙ (n=1, 2, 3, . . . , N), and a processor P. Each loudspeaker Zₙ is connected to an associated filter Fₙ. All filters Fₙ are connected to processor P. It is observed that FIG. 1 only gives a schematic view: the circuit may be implement in many different ways. The filters Fₙ may, for instance, be part of the processor P when the latter is implemented as a computer arrangement. Then, the filters Fₙ are software modules in such a computer. However, other implementations, both digital and analogue, can be conceived.

The processor P may include a plurality of memory components, including a hard disk, Read Only Memory (ROM), Electrically Erasable Programmable Read Only Memory, and Random Access Memory (RAM). Not all of these memory types need necessarily be provided. Moreover, these memory components need not be located physically close to the processor P but may be located remote from the processor P.

The processor 1 may be connected to a communication network, for instance, the Public Switched Telephone Network (PSTN), a Local Area Network (LAN), a Wide Area Network (WAN). The processor P may be arranged to communicate with other communication arrangements through such a network.

The processor P may be implemented as stand alone system, or as a plurality of parallel operating processors each arranged to carry out subtasks of a larger computer program, or as one or more main processors with several sub-processors. Parts of the functionality of the invention may even be carried out by remote processors communicating with processor P through the network.

In order to compare the performance of array systems, many evaluation parameters have been suggested. The directivity factor is one of the most important evaluation parameters for array systems. For loudspeaker systems, the directivity factor is defined by the ratio of the acoustic intensity in some far field point in a preferred direction and the intensity obtained in the same point with a monopole source that radiates the same acoustic power as the array system [6]. This measure shows how much available acoustic power is concentrated onto the preferred direction by the designed system. Using the principle of acoustical reciprocity, the directivity factor of a loudspeaker array can be obtained by the same equation that applies for microphone arrays. For microphone arrays, the equation for the directivity factor is given by [1]

$$Q ( ω ) = \frac{{max}_{θ , φ} \{ {F}^{H} {W}^{*} {W}^{H} F \}}{{F}^{H} {S}^{T} F} , \qquad ( 1 )$$

For the case of a loudspeaker array, the parameters are defined as follows:
* means the conjugate operator,
^{H} means the Hermitian transpose,
F(ω) is the filter array which controls the output and is connected to the loudspeaker array:

F(ω)=[F₁(ω)F₂(ω) . . . F_{N}(ω)]^{T} (2)
W(ω) is the relative propagation factor from each loudspeaker Zₙ to a far field reception point, denoted by the following vector equations of the endfire array system,

$$W ( ω ) = {[ {Γ}_{1} {e}^{\frac{j ω {d}_{1} cos θ}{c}} {Γ}_{2} {e}^{\frac{j ω {d}_{2} cos θ}{c}} … {Γ}_{N} {e}^{\frac{jω {d}_{N} cos θ}{c}} ]}^{T} . \qquad ( 3 )$$

Here, Γₙ (n=1, 2, . . . , N) denotes the directional factor of each loudspeaker Zₙ, and dₙ=location of each loudspeaker (Zₙ) relative to an origin.
For the case of microphone arrays, S(ω) is a coherence function of the noise field as applicable to the microphone array. If the background noise is assumed as uniform and isotropic, the coherence matrix S(ω) is written by [1, 2]

$${S}_{mn} = \frac{sin [ k ( {d}_{m} - {d}_{n} ) ]}{k ( {d}_{m} - {d}_{n} )} , \qquad ( 4 )$$

where the subscripts m and n mean the index of the acoustic devices, dₘ and dₙ, are the positions of the devices relative to an origin (so, dₘ−dₙ=distance between two acoustic devices), and k=the wave number. Translated from microphone to loudspeaker arrays, the coherence matrix S(ω) shows the weighting of the relevance of the radiation direction to optimize the suppression in certain directions. If the coherence matrix S(ω) is taken uniform and isotropic this means that all suppression directions are taken of equal importance.

Usually, the directivity index (DI), the logarithmic value in dB of the directivity factor Q(ω), is used. Another important evaluation parameter is the noise sensitivity (NS). For microphone arrays, this quantity shows the amplification ratio of uncorrelated noise, so-called internal noise, to the signal and is given by [1]

$$Ψ ( ω ) = \frac{{F}^{H} ( ω ) F ( ω )}{{F}^{H} ( ω ) {W}^{*} ( ω ) {W}^{T} ( ω ) F ( ω )} . \qquad ( 5 )$$

Usually, the noise sensitivity is also expressed on a dB scale. Translating to loudspeaker arrays the noise sensitivity transforms in a measure for the output strength of the array as compared to the output of a single loudspeaker unit Zₙ and is in effect the inverse of the array gain of the array system.

### Optimal Beamformer

The optimization problem of the array system is how to find a maximum directivity index DI in combination with a minimum noise sensitivity NS. The solution in accordance with the invention is in applying a super resolution beamforming signal processing by the filters Fₙ. This requirement can be defined by the following minimization expression:

$${min}_{F ( ω )} {F}^{H} ( ω ) {S}^{T} ( ω ) F ( ω ) , \qquad ( 6 )$$

subject to F^{T}(ω) W(ω)=1.

These equations state that the output of the array system is minimized, using a directional weighting according to matrix S and with the constraint that the array has unity gain in the target (end fire) direction.

The solution of Equation (6) can be obtained by the Lagrange method and the solution is called the minimum variance distortion less response (MVDR) beamformer given by the following equation for an optimal filter Fₒₚₜᵢₘₐₗ(ω), as is also used in the field of microphone arrays:

$${F}_{optimal}^{T} ( ω ) = \frac{{W}^{H} ( ω ) {S}^{- 1} ( ω )}{{W}^{H} ( ω ) {S}^{- 1} ( ω ) W ( ω )} . \qquad ( 7 )$$

Unfortunately, this exact solution cannot be used in real situations due to the high noise sensitivity at low frequencies caused by the high condition number of the coherence matrix S(ω) in this frequency range. To solve this mathematical problem, in the field of antenna arrays, Gilbert and Morgan [3] suggested adding a stability factor β to the diagonal of the coherence matrix S(ω). Here, this approach as suggested by Gilbert and Morgan is also used. By using this method, Equation (7) can be modified to

$${F}_{optimal , β}^{T} = \frac{{{W}^{H} ( S + β I )}^{- 1}}{{{W}^{H} ( S + β I )}^{- 1} W} . \qquad ( 8 )$$

### Optimization of Design Parameters

### Effect of Design Parameters

The directional characteristics of the loudspeaker array system depend on the array design parameters: the number of loudspeakers Zₙ, their mutual spacing and distribution pattern, the directional characteristics of the single loudspeakers Zₙ and the applied beamforming filters Fₙ. For the optimal beamformer, a filter shape of the array system is determined by Equation (8). Therefore, the parameter to be optimized is the stability factor β(ω). In order to investigate the effect of each design parameter, a parametric study was conducted with Equations (1) and (5). Each loudspeaker Zₙ is assumed to be a monopole and the effects of reflection and scattering are ignored.

With uniform spacing and the same number of loudspeakers Zₙ, it is observed that the same directional characteristics apply if we normalize the frequencies according to the high frequency limit fₕ given by

fₕ=c/2d, (9)

where c denotes the speed of sound and d means the spacing between two adjacent loudspeakers Zₙ.

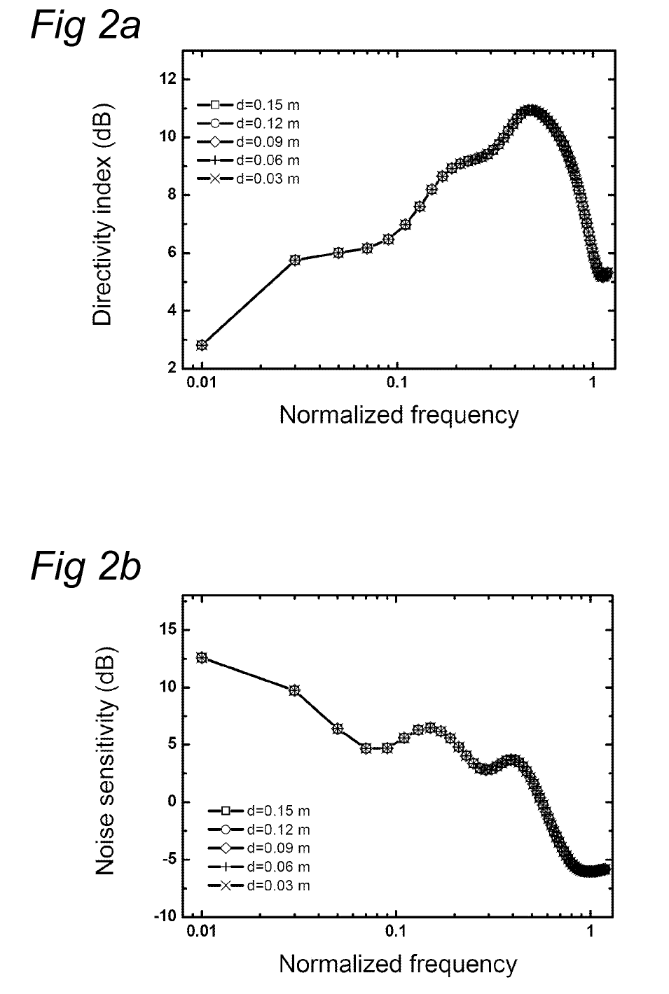

FIGS. 2a and 2b, respectively, show the most important directional characteristics, i.e., directivity index DI and noise sensitivity NS, respectively, of arrays which have different spacing and the same number of loudspeakers Zₙ with N=4. The stability factor β is set at 0.01. The directivity index DI and noise sensitivity NS of these arrays coincide perfectly as a function of the normalized frequency (i.e., relative to fₕ).

The number of loudspeakers Zₙ determines the maximum value of the directivity index DI. For an endfire array system, the maximum directivity index DI is determined by [1]

DIₘₐₓ=20 logN, (10)

where N denotes the number of loudspeakers Zₙ.

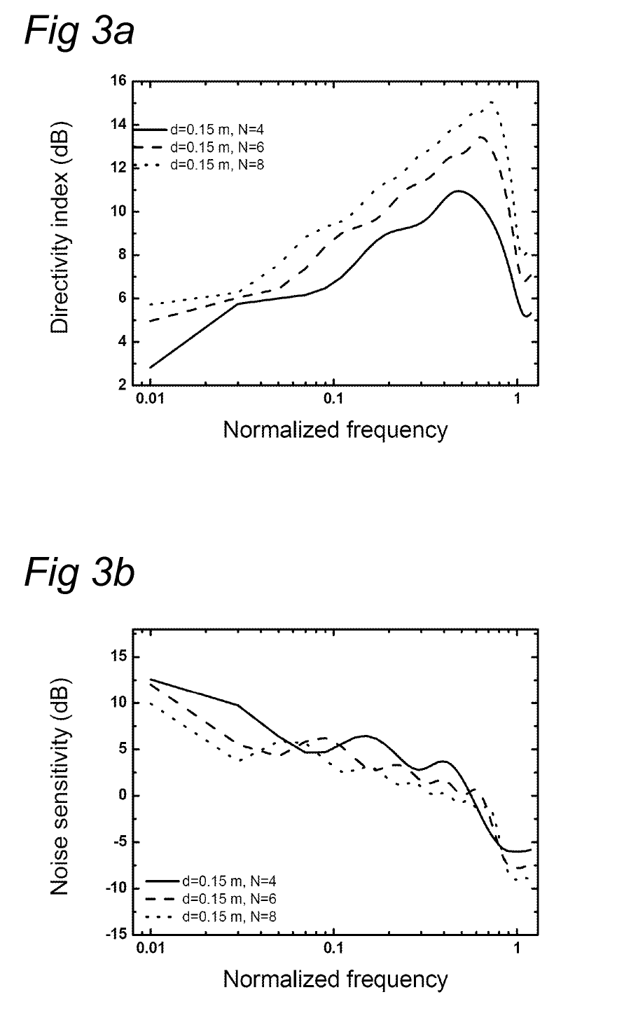

FIGS. 3a and 3b show the results of a parametric study with β=0.01. Directivity index DI increases following the increase of N over the whole frequency range lower than fₕ. The frequency with the maximum directivity index DI value also increases, but it remains below fₕ. Noise sensitivity NS shows a tendency of decreasing with increasing frequency and it reaches a minimum value at f=fₕ. These results are in agreement with the aforementioned theory.

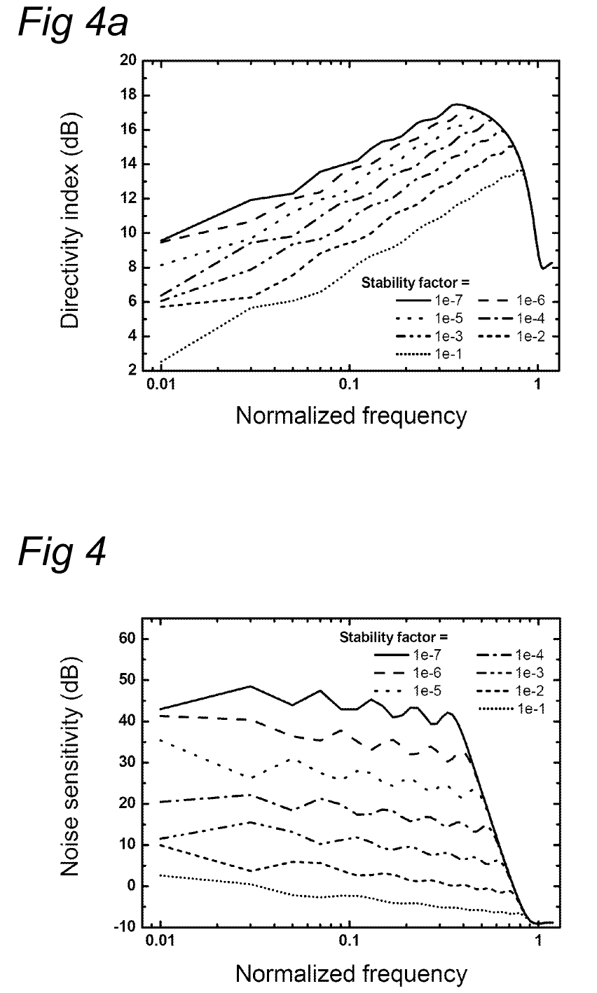

FIGS. 4a and 4b show the change of the directional characteristics in dependence on the stability factor β. Here, the number of loudspeakers Zₙ is 8 and the uniform spacing between the loudspeakers Zₙ is 0.15 m. With increasing β, the directivity index DI and noise sensitivity NS decrease up to the frequency of maximum directivity index DI. At higher frequencies, directivity index DI and noise sensitivity NS are no longer controllable by β.

### Optimization of the Stability Factor

The stability factor β was suggested to solve the self-noise problem of the equipment. However, the inventor of the present invention has found that it can also be applied to control the directional characteristics of the array system without changing its configuration. The optimal value of the stability factor β for this purpose cannot be obtained by direct methods. For that reason, in the case of a microphone array, several iterative methods were suggested to obtain the optimal value [1]. The plot of noise sensitivity NS vs. directivity index DI can give useful information to select β.

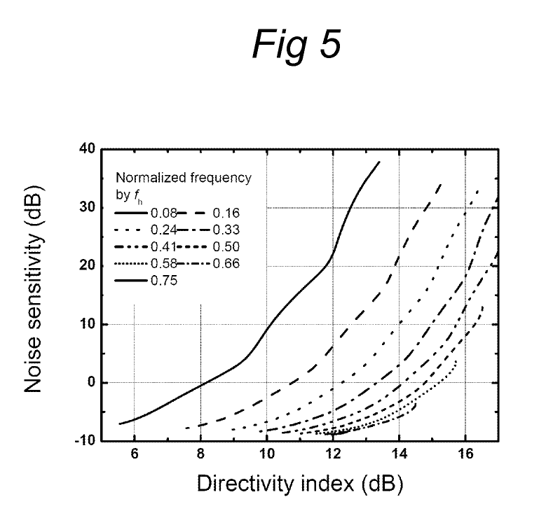

Consider an array system with N=8 and d=0.15 m which was used in the previous section. The range of β is from 10⁻⁷ to 10⁻¹. FIG. 5 shows the DI-NS plot in dependence on β for several frequencies. Increasing the frequency, the variation range of directivity index DI and noise sensitivity NS decrease with the same range of β. This is related to the result of the previous section that the directional characteristics are no longer controllable at frequencies higher than fₕ. If the target performance of the array system is given by a specific range of directivity index DI and noise sensitivity NS, the value of the stability factor can be selected on these DI-NS plots. Practical values of directivity index DI depend on the number of loudspeakers N. For N=8, the theoretical maximum is DI=18 dB. Noise sensitivity NS will usually be kept small, say lower than 1 to 5, to allow sufficient acoustical output (the array gain of the system is inversely proportional to the noise sensitivity NS).

### Example I

### Constant Beam Width Array

As an example, the inventor considered the design of a constant beamwidth array (CBA) system. The simplest concept to design a CBA is using the different array sets, as computed for different values of the Helmholtz number kd. With this method, however, redundant acoustic devices are required. In a specific array system, it can be said that the same value of directivity index DI means the same beamwidth. Hence, the CBA system can be designed by the selection of the frequency dependent factor β(ω) that gives a constant directivity index DI over the whole target frequency range.

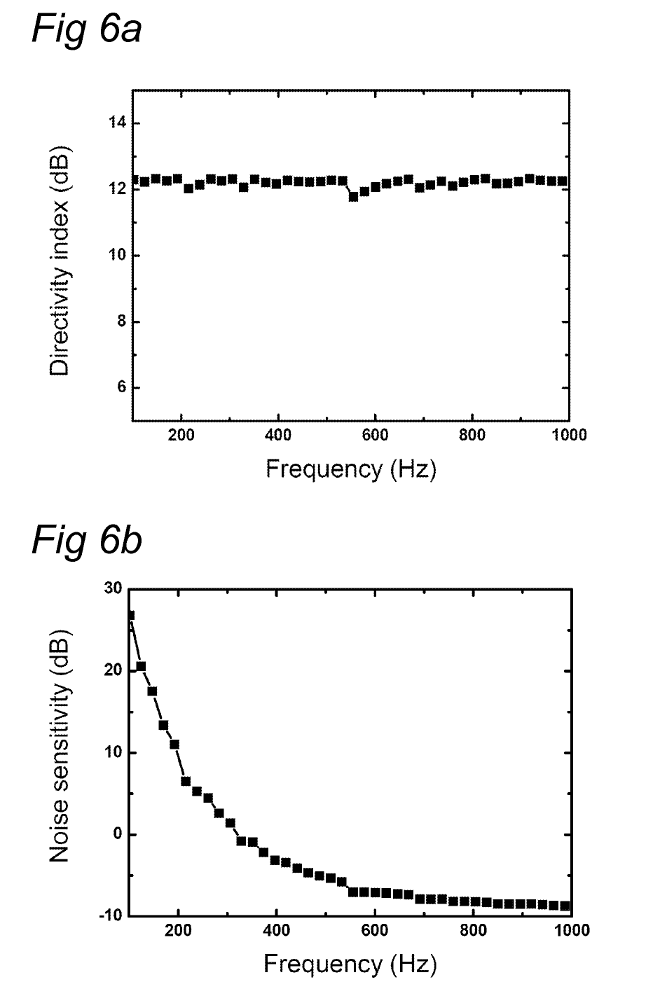

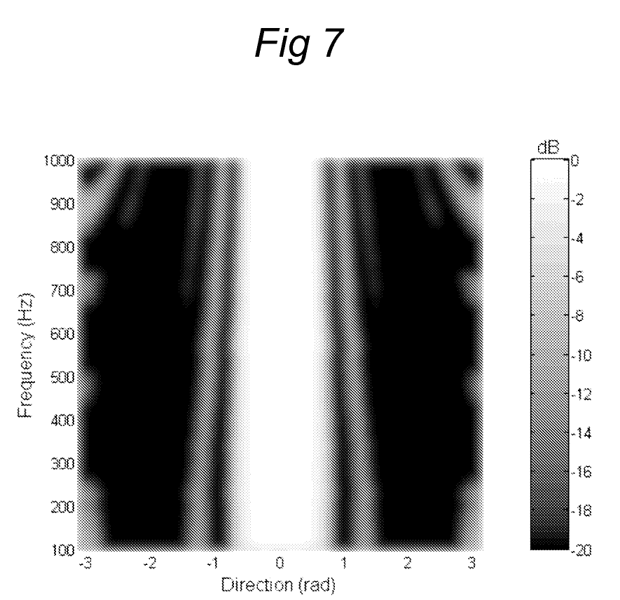

The inventor considered an array system which has 8 loudspeakers Zₙ with a uniform spacing of 0.15 m. The directivity index DI and noise sensitivity NS of this system as a function of β are shown in FIG. 5. The target frequency range was from 0.1 to 1 kHz and the target value of directivity index DI was 12 dB which is the highest value in FIG. 5 with noise sensitivity NS<30 dB. To satisfy these conditions, the β values on the directivity index DI line of 12 dB were selected from FIG. 5. The directivity index DI and noise sensitivity NS, respectively, for the selected β's are plotted in FIGS. 6a and 6b, respectively. FIG. 7 shows the directional pattern of the resulting array system. This figure shows that a constant beamwidth is successfully obtained within the target frequency range.

### Mutual Interactions Between the Loudspeakers

### Directional Factor of the Total Sound Field

Up to now, the effect of reflection and scattering induced by the loudspeaker Zₙ enclosures has been ignored (Γₙ=1, n=1, 2, . . . , N). In the case of a microphone array system, the size of the transducers is usually sufficiently small compared to the wavelength. However, for loudspeaker arrays, the size of the loudspeaker units Zₙ should be much larger to obtain sufficient radiation power. Therefore, both the directivity of the single loudspeaker Zₙ itself related to its own geometry and the system of loudspeakers Zₙ owing to the scattering from the other loudspeakers Zₙ should be considered. Usually, the scattering effect is considered as being induced by an incident field and the total field is described by summation of these two sound fields. The directional pattern of the individual loudspeakers Zₙ can be found by summation of the direct field from the loudspeaker Zₙ itself and the scattering field induced by the other loudspeakers Zₙ. The analytical solution for the scattered field can be found under specific conditions [7]. However, the directional pattern of the total field is hard to derive theoretically, because the scattering field of each loudspeaker Zₙ also becomes the incident field to the other loudspeakers Zₙ, recursively. For that reason, a numerical method or measurement is useful to obtain the directivity of the total sound field.

### Example II

### Derivation of the Optimal Filters with a Numerical Method

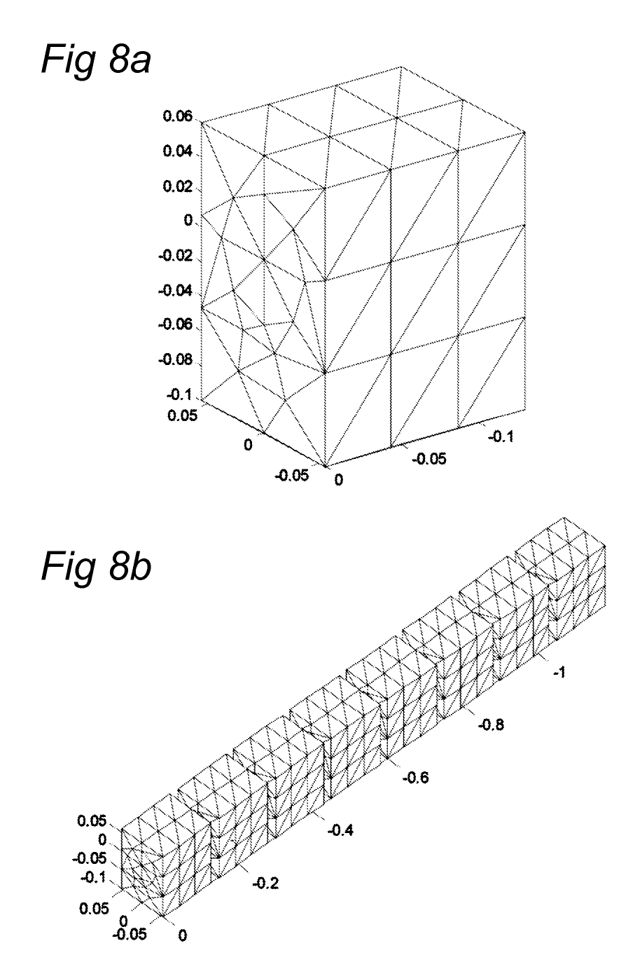

As a design example, a loudspeaker array system was chosen that consists of 8 loudspeakers Zₙ with 0.15 m of uniform spacing. Each loudspeaker Zₙ had a loudspeaker box and a loudspeaker diaphragm. The size of each loudspeaker box was 0.11(W)×0.16 (H)×0.13 (D) m and the diameter of the loudspeaker diaphragm was 0.075 m. The boundary element method (BEM) was applied to obtain the directional pattern of each loudspeaker Zₙ in the given array configuration. Each loudspeaker Zₙ was modelled by 106 triangular elements as shown in FIGS. 8a and 8b. The characteristic length of the model elements was taken as 0.057 m, which gives 1 kHz as a high frequency limit based on the λ/6-criteria (fₕ of the array system was 1.1 kHz). All nodes except the center of the loudspeaker diaphragm were modelled as a rigid boundary. In order to obtain the directional pattern of each loudspeaker Zₙ in the array system, the calculation was carried out one by one with the complete system. For example, when the directional pattern of the first loudspeaker Z₁ was calculated, only the loudspeaker diaphragm center of the first loudspeaker Z₁ was activated and other nodes were inactive. The calculation plane was selected as a circle in the plane of the active node of the activated loudspeaker Zₙ.

Optimal filters were calculated by two methods. With both methods the aim was to obtain an array with a constant noise sensitivity NS of 20 dB over a large frequency range. With the first method it was assumed that every loudspeaker unit Zₙ behaves as a monopole and the scattering effect of the geometry was ignored. With the other method the directional pattern of each unit and the effect of scattering was taken into account both in the design of the optimized filters and in the computation of the directivity index DI and noise sensitivity NS.

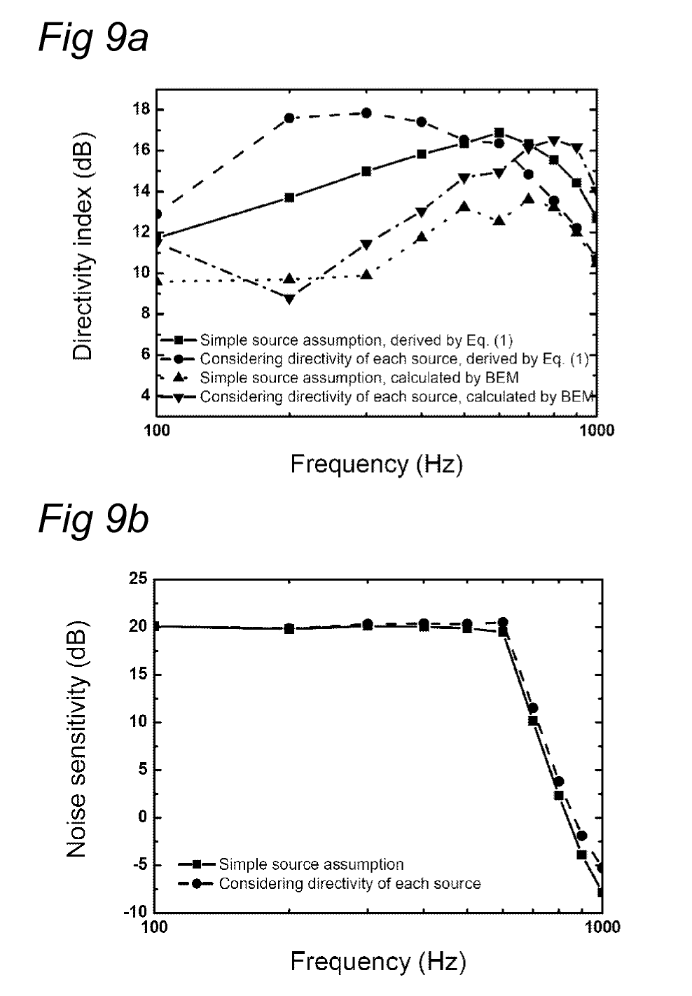

From these designed filters the directivity index DI can be calculated in two different ways. One way is to insert the filters and propagation factors directly into Equation (1). Another approach is to simulate a real measurement by inserting the required velocities at the loudspeaker diaphragm centers in the BEM model and than to compute the far field response in different directions. All four combinations are presented in FIG. 9a. In addition, FIG. 9b shows the noise sensitivity NS for the two design methods, calculated with Equation (5).

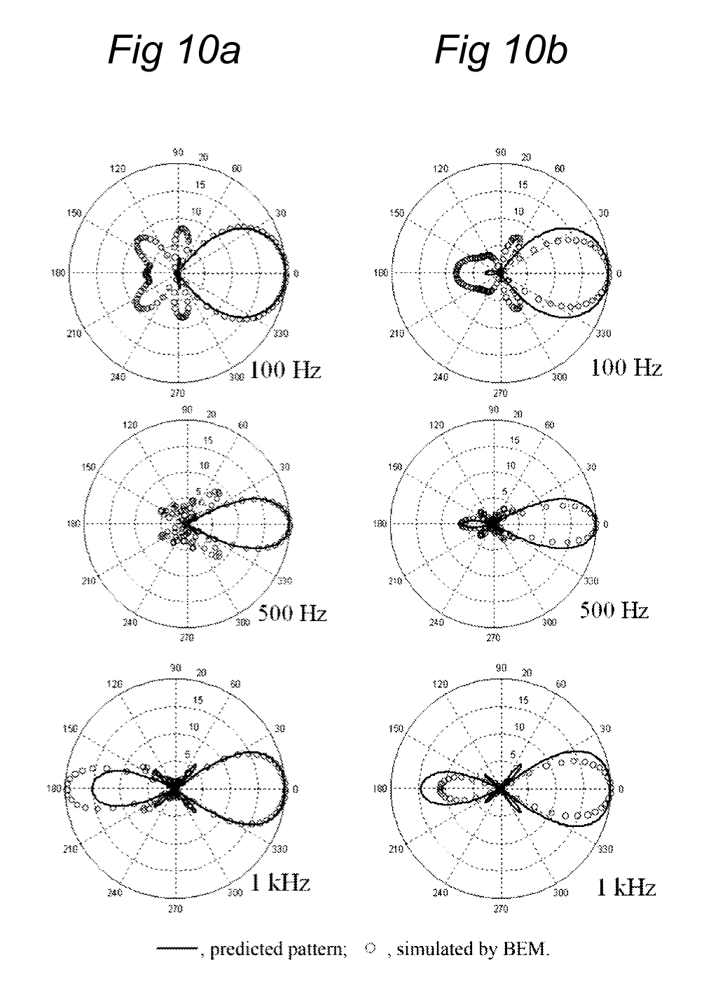

FIGS. 10a and 10b show the corresponding polar diagrams based on the same methods as those of FIG. 9a: FIG. 10a shows the situation in which a filter is applied under simple source assumption and FIG. 10b under considering the directivity of the loudspeakers Zₙ. The predicted values from calculations with Equation (1) show a considerable positive influence due to the directivity of the loudspeakers Zₙ at lower frequencies, but the directivity index DI is considerably lower when the BEM-calculation method is applied. With the BEM method it is seen that the filters that include the directivity of the loudspeakers Zₙ result in higher directivity index DI values at almost the whole frequency range compared to the case of the filters derived under simple source assumptions. This is probably due to the high mutual screening of the loudspeakers Zₙ in this case.

### Measurements

In order to observe the performance of the designed filters in a real situation, measurements were carried out under anechoic conditions. The size of the loudspeakers Zₙ, and the geometry were the same as in FIG. 8. The filters of the constant beam width array that was introduced above was applied to this system. The filters were derived by two methods: the first design was based on the simple source assumption (monopole) and the second design was based on the loudspeaker directivity as obtained from the BEM simulation. The target value of the directivity index DI was chosen to be 12 dB.

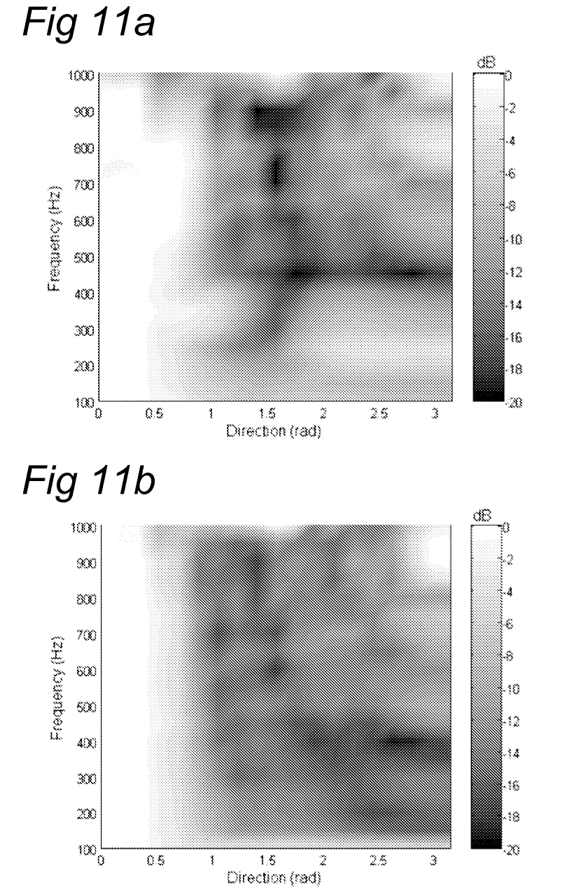

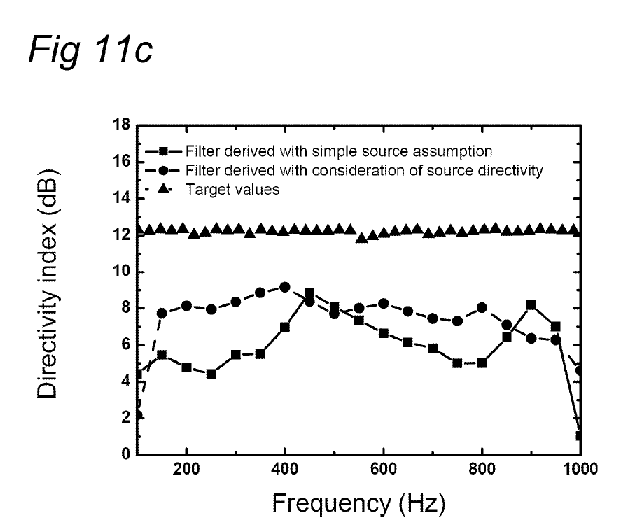

FIGS. 11a, 11b, and 11c show measured directional patterns of the prototype endfire array with constant beam width. FIG. 11a shows a grey scale picture of directivity index in dB as a function of both frequency and direction for the case of a simple source assumption. FIG. 11b shows the same as FIG. 11b but then using directivity of a single source obtained by a numerical model. FIG. 11c shows a comparison of directivity index DI for different filters as a function of frequency. Taking into account the directivity of the loudspeakers Zₙ, (FIG. 11b) shows better results than when simple monopole behaviour of the loudspeakers Zₙ, is assumed (FIG. 11a), however, it still has a higher sound level in off-axis directions than expected from the theoretical prediction in FIG. 7. FIG. 11c shows a comparison of directivity indexes DI's. Both measured cases show lower directivity index DI values than the target value of 12 dB, however the case using the filter considering the directivity of the loudspeakers Zₙ has a higher and more stable directivity index DI as compared to the case using the filters derived under simple source assumptions.

### CONCLUSION

In the study performed by the inventor, the basic theory of an endfire loudspeaker array system is investigated and the effect of design parameters, number of loudspeaker units, their spacing, length of the array, and the use of the stability factor of the optimal beamformer are observed. The number of loudspeakers determines the maximum value of the directivity index DI, and the same directional characteristics are observed according to the frequency normalized by the high frequency limit. Increasing of the stability factor β causes a higher suppression of both the directivity index DI and noise sensitivity NS, however, this only applies below the frequency of maximum directivity index DI. To select the optimal value of the stability factor β for a given target value, the DI-NS plot is applied. Array length and number of loudspeakers are often limited by available budget and space. Therefore the stability factor β can be a useful parameter to control the directional characteristics of the array. As an example, a constant beam width array system is designed by the proper selection of stability factors. Moreover, the directional pattern considering the effect of other loudspeakers is applied to the optimal filter design to obtain an even better optimized filter. Preliminary measurements on a prototype array system show that the directivity index DI's are lower than those of the simulations but they are promising for further research on optimization of this kind of endfire loudspeaker array systems.

### REFERENCES

[1] I. Merks, Binaural application of microphone arrays for improved speech intelligibility in a noisy environment, Ph.D. thesis, Technical University of Delft (2000).
[2] M. Brandstein and D. Ward, Microphone Arrays, Chap. 2 (Springer, N.Y., 2001).
[3] E. N. Gilbert and S. P. Morgan, “Optimum design of directive antenna arrays subject to random variations,” Bell Syst. Tech. J., 34, 637-663 (1955).
[4] M. M. Boone, “Directivity measurements on a highly directive hearing aid: the hearing glasses”, 120^{th} AES Convention, Paris, 2006 May 20-23, paper nr. 6829.
[5]H. Cox, R. M. Zeskind and T. Kooij, “Practical supergain,” IEEE Trans. on Acoust. Speech Signal Processing, 34, 393-398 (1986).
[6] L. E. Kinsler, A. R. Frey, A. B. Coppens and J. V. Sanders, Fundamentals of Acoustics, Chap. 7 (John Wiley & Sons, New York, 2000).
[7] E. G. Williams, Fourier Acoustics—Sound Radiation and Nearfield Acoustical Holography, Chap. 6 (Academic Press, London, 1999).

1-10. (canceled)

11. A loudspeaker system comprising:
an array of three or more loudspeakers (Zₙ, n=3, 4, . . . N) arranged on a line and to operate as an endfire array, a set of filters (Fₙ, n=3, 4, . . . N), each loudspeaker (Zₙ) being connected to one corresponding filter (Fₙ), the filters (Fₙ) forming a filter array and being super resolution beamforming filters such as to provide said endfire array with a pre-designed directivity index (DI) and a pre-designed noise sensitivity (NS), by minimizing the output of the system in accordance with:
$${min}_{F ( ω )} {F}^{H} ( ω ) {S}^{T} ( ω ) F ( ω ) ,$$
where:
F(ω) is the filter array which controls the output of the system and is connected to the loudspeaker array;
^{H} means Hermitian transpose;
S(ω) is a coherence matrix of the loudspeaker array, showing a weighting of relevance of radiation direction of the loudspeaker array to optimize suppression of sound in certain predetermined directions,
subject to the condition that the array has unity gain in a target direction, i.e.:
F^{T}(ω)W(ω)=1.
where:
W(ω) is the relative propagation factor from each loudspeaker (Zₙ) to a far field reception point, denoted by the following vector equation of the loudspeaker system:
$$W ( ω ) = {[ {Γ}_{1} {e}^{\frac{j ω {d}_{1} cos θ}{c}} {Γ}_{2} {e}^{\frac{j ω {d}_{2} cos θ}{c}} … {Γ}_{N} {e}^{\frac{j ω {d}_{N} cos θ}{c}} ]}^{T}$$
where: Γₙ (n=1, 2, . . . , N) denotes a directional factor of each loudspeaker (Zₙ);
dₙ=location of each loudspeaker (Zₙ) relative to an origin.

12. The loudspeaker system according to claim 11, wherein said super resolution beamforming filters (Fₙ) are designed in accordance with the following equation for an optimal filter array Fₒₚₜᵢₘₐₗ(ω) comprising said set of filters (Fₙ):
$${F}_{optimal , β}^{T} = \frac{{{W}^{H} ( S + β I )}^{- 1}}{{{W}^{H} ( S + β I )}^{- 1} W} .$$
where:
β is a stability factor, the value of β being selected such that said pre-designed directivity index (DI) is within a first range and said pre-designed noise sensitivity (NS) is within a second range;
I is unity matrix;
F^{T}_{optimal,β} is the optimal filter array in dependence on stability factor β.

13. The loudspeaker system according to claim 12, wherein said stability factor β is either a constant or frequency dependent.

14. The loudspeaker system according to claim 11, wherein said endfire array is a constant beam width array.

15. The loudspeaker system according to claim 14, wherein said directivity index has a substantial constant value over a predetermined frequency range.

16. The loudspeaker system according to claim 15, wherein said frequency range is between 0.1 and 1 kHz.

17. The loudspeaker system according to claim 11, wherein said loudspeaker array has 4 to 8 loudspeakers.

18. The loudspeaker system according to claim 11, wherein said loudspeakers are equidistantly spaced at a mutual distance of 0.15 cm.

19. A set of filters comprising:
a set of filters for a predetermined array of three or more loudspeakers (Zₙ, n=3, 4, . . . N) arranged on a line and to operate as an endfire array, each filter of said set of filters (Fₙ, n=3, 4, . . . N) being designed to be connected to a corresponding loudspeaker (Zₙ), the filters (Fₙ) forming a filter array and being super resolution beamforming filters such as to provide said endfire array with a pre-designed directivity index (DI) and a pre-designed noise sensitivity (NS), by minimizing the output of the system in accordance with:
$${min}_{F ( ω )} {F}^{H} ( ω ) {S}^{T} ( ω ) F ( ω ) ,$$
where:
F(ω) is the filter array which is arranged to control the output of the system when connected to the loudspeaker array;
^{H} means Hermitian transpose;
S(ω) is a coherence matrix of the loudspeaker array showing a weighting of relevance of radiation direction of the loudspeaker array to optimize suppression of sound in certain predetermined directions,
subject to the condition that the array has unity gain in a target direction, i.e.:
F^{T}(ω)W(ω)=1.
where:
W(ω) is the relative propagation factor from each loudspeaker (Zₙ) to a far field reception point, denoted by the following vector equation of the loudspeaker system:
$$W ( ω ) = {[ {Γ}_{1} {e}^{\frac{j ω {d}_{1} cos θ}{c}} {Γ}_{2} {e}^{\frac{j ω {d}_{2} cos θ}{c}} … {Γ}_{N} {e}^{\frac{j ω {d}_{N} cos θ}{c}} ]}^{T}$$
where: Γₙ (n=1, 2, . . . , N) denotes a directional factor of each loudspeaker (Zₙ);
dₙ=location of each loudspeaker (Zₙ) relative to an origin.

20. The set of filters according to claim 19, wherein said super resolution beamforming filters (Fₙ) are designed in accordance with the following equation for an optimal filter array Fₒₚₜᵢₘₐₗ(ω) comprising said set of filters (Fₙ):
$${F}_{optimal , β}^{T} = \frac{{{W}^{H} ( S + β I )}^{- 1}}{{{W}^{H} ( S + β I )}^{- 1} W} .$$
where:
β is a stability factor, the value of β being selected such that said pre-designed directivity index (DI) is within a first range and said pre-designed noise sensitivity (NS) is within a second range;
I is unity matrix;
F^{T}_{optimal,β} is the optimal array in dependence on stability factor β.
